(19) United States
(12) Patent Application Publication
(10) Pub. No.: US 2016/0232350 A1
(43) Pub. Date: Aug. 11, 2016

(54) SYSTEM AND METHOD FOR INSPECTING DATA THROUGH FILE FORMAT CONVERSION

(71) Applicant: SOFTCAMP CO., LTD., Gangnam-gu, Seoul (KR)

(72) Inventors: Steve BAE, Gyeonggi-do (KR); Jong-deok BAEK, Seoul (KR)

(21) Appl. No.: 15/030,044

(22) PCT Filed: Sep. 29, 2014
(86) PCT No.: PCT/KR2014/009090

§ 371 Date: Apr. 15, 2016

(30) Foreign Application Priority Data
Oct. 17, 2013 (KR) 10-2013-0123902
Oct. 17, 2013 (KR) 10-2013-0123904

(51) Int. Cl. G06F 21/56; G06F 17/30

(52) U.S. Cl. CPC G06F 21/562; G06F 17/30076; G06F 17/30117; G06F 2221/034

(57) ABSTRACT

A system and method for inspecting data through file format conversion, which filter out various types of malicious code attached to data, entering into a terminal from the outside and stored in the terminal, by inspecting the data, thereby enabling the stable execution of the data. The method includes a stored file inspection step of converting the file format of a stored file inside the terminal and then restoring the converted file format to an original file format.

### BACKGROUND

The present invention relates to a system and method for inspecting data through file format conversion, which filter out various types of malicious code attached to data, entering into a terminal from the outside and stored in the terminal, by inspecting the data, thereby enabling the stable execution of the data.

With the development of data processing systems (hereinafter “terminals”), such as computers or mobile terminals, for operating and managing various types of data and with the development of communication networks, such as the Internet, for mediating intercommunication between terminals, a massive amount of data is being transferred via not only e-mail and communication between terminals but also movable storage media, such as USB memory and a CD/DVD.

These pieces of data include not only information beneficial to users but also information harmful to users. Examples of the harmful data may include malicious code, such as a computer virus, spy-ware, ad-ware, and a hacking tool. The malicious code may cause a fatal damage to a terminal that is used by a specific user or a plurality of unspecified users, may cause an operation, not desired by a user, to be performed in a terminal, and may cause even a user's personal information to leak from a terminal, thereby causing economic loss to a corresponding user. Accordingly, various types of tools for monitoring and blocking such malicious code have been constructed.

Meanwhile, the malicious code enters into users' terminals via various routes, and representative paths include movable storage media, such as an external hard disk, USB memory, a CD/DVD, a smart phone and the like, and communication means, such as ptp, ftp, e-mail and the like. For reference, the movable storage media and communication means are collectively referred to as data feed means 200.

In this case, e-mail is one of the communication means that are frequently used by Internet users. Files of various formats are attached to e-mails, and the e-mails may be transmitted to other terminals. Meanwhile, since e-mail imposes low burden regarding transmission and reception and a method for checking mails is simple, e-mail is widely used as a means by which malicious code is spread via the Internet.

Furthermore, malicious code may be linked to an attached file that is intentionally attached to an e-mail by a sender. Although the sender has attached the attached file in good part, malicious code may be illegitimately linked to the attached file and transmitted to a recipient, and the malicious code may be installed in the client of the recipient in such a way that the recipient downloads the attached file.

As a result, the sender must inspect the attached file before attaching the attached file to the e-mail, or the recipient must inspect the attached file before receiving it. However, if a malicious sender intentionally transmits an attached file to which malicious code has been linked to a recipient via e-mail even when a user has paid the above-described attention, a limitation arises in which the client of the recipient must be easily infected with the malicious code.

Meanwhile, a data feed means is a well-known, commonly used device that enables data stored in a terminal to be stored, to be transferred to another terminal, and to be executed therein. A user chiefly uses a data feed means in the case of data requiring security or in order to avoid the inconvenience of logging in to e-mail.

Meanwhile, in the case of movable storage media, malicious code that has been installed with malicious intention may be linked to a stored file, and malicious code stored in a movable storage medium may be automatically executed according to an “automatic execution” option regardless of a user's intention and a corresponding system or another system in an organization may be easily infected with the malicious code. In such a case, there occurs a serious problem in which before a user inspects whether a stored file inside the movable storage medium has been infected with malicious code, infection with malicious code has already occurred simultaneously with the insertion of the movable storage medium. Accordingly, no matter how much attention a user pays to inspection for malicious code using a security solution such as a computer vaccine, the transfer of malicious code via the movable storage medium cannot be completely blocked, and thus a limitation arises in that the security of the terminal of the user against infection with the malicious code cannot be guaranteed.

As described above, a terminal can receive malicious code via various data entry paths, and an incident in which the terminal is infected with the received malicious code and operates erroneously or an incident in which various types of secure data inside the terminal are illegitimately leaked to the outside has frequently occurred.

Therefore, in order to prevent such incidents, there has been an urgent demand for a fundamental means for inspecting data entering from the outside.

### SUMMARY OF THE INVENTION

Accordingly, the present invention is conceived to overcome the above-described problem, and an object of the present invention is to provide a system and method for inspecting data through file format conversion, which inspect data entering from the outside, thereby overcoming the problem in which a receiving terminal is infected through the medium of the data.

In order to accomplish the above-described object, the present invention provides a method for inspecting data through file format conversion, including:

a stored file inspection step of converting a file format of a stored file inside a terminal and then restoring the converted file format to an original file format.

According to the present invention, various types of malicious code attached to entering data are separated and eliminated by performing the file format conversion of the data, thereby achieving the effect of fundamentally preventing malicious code from being spread through the reception of the data.

### BRIEF DESCRIPTION OF DRAWINGS

FIG. 1 is a block diagram showing an embodiment of a system for inspecting data according to the present invention; and

FIG. 2 is a flowchart sequentially showing a method of inspecting data according to the present invention.

### DESCRIPTION OF REFERENCE SYMBOLS

100: terminal 110: storage path control module
120: isolated space management module
130: drive 140: storage disk 141: isolated space
150: OS 200: data feed means

### DETAILED DESCRIPTION OF THE INVENTION

The above-described features and effects of the present invention will be more apparent from the following detailed description taken in conjunction with the accompanying drawings, and, accordingly, those having ordinary knowledge in the art to which the present invention pertains can easily practice the technical spirit of the present invention. Although various modifications may be made to the present invention and the present invention may have various forms, specific embodiments will be illustrated in the drawings and will be described in the following description in detail. However, it should be appreciated that this is not intended to limit the present invention to specific disclosed forms but the present invention includes all modifications, equivalents and substitutions included in the spirit and technical scope of the present invention. The terms used herein are used merely to describe specific embodiments, and are not intended to limit the present invention.

Specific content for practicing the present invention will be described in detail below with reference to the accompanying drawings.

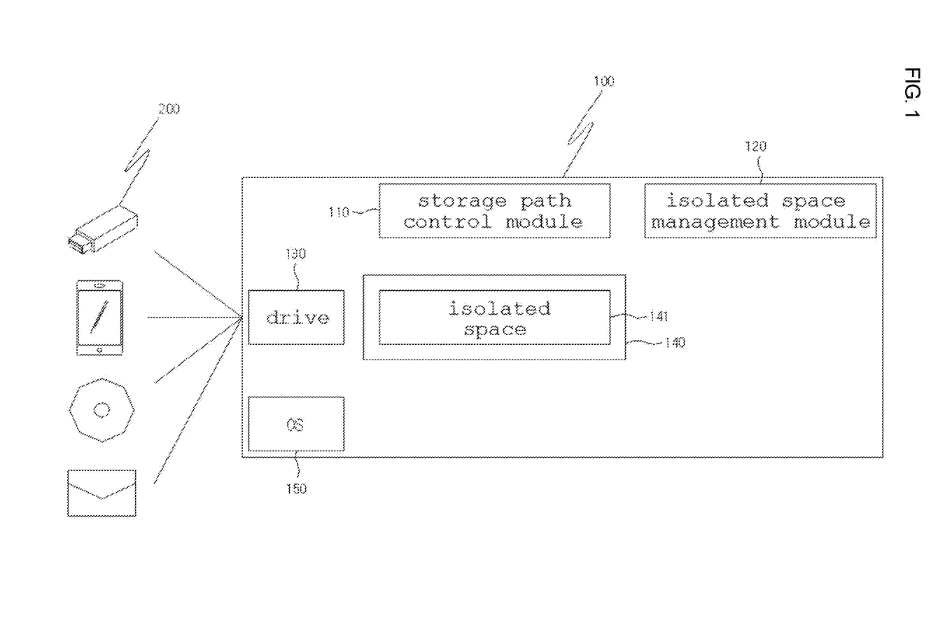

FIG. 1 is a block diagram showing an embodiment of a system for inspecting data according to the present invention, and the following description is given with reference to this drawing.

The system for inspecting data according to the present invention is designed to classify a stored file transferred from various types of data feed means 200 and to enable a terminal 100 to separately process the classified stored file. The system for inspecting data includes a drive 120 configured to identify a data feed means 200, a storage path control module 110 configured to set a dedicated storage path based on the data feed means 200 identified by the drive 120, and an isolated space management module 120 configured to generate and delete an isolated space in a storage disk 140 or a movable storage medium and manage the isolated space.

The drive 120 is a common device that is dedicated to the data feed means 200 and installed in the terminal 100. The drive 120 may be a movable storage medium-dedicated drive, such as an external hard disk, USB memory, a smart phone or the like, configured to communicate via a USB cable, a drive configured to read a CD/DVD or enter data into a CD/DVD, or a drive, such as a web browser, configured to check a connection to an e-mail server or the like.

When the storage path control module 110 detects the data feed means 200 connecting with the drive 120 via the details of the execution of an OS 150, the storage path control module 110 may control the OS 150 so that a stored file (or an attached file; hereinafter the “stored file”) transmitted from the data feed means 200 can be limitedly transferred to a designated folder or disk drive (hereinafter the “isolated space”). Furthermore, before the stored file transmitted from the data feed means 200 is stored in the storage space of the terminal or transferred to a separate isolated space 141, the file format of the stored file may be converted, thereby eliminating various types of malicious code attached to the stored file.

For example, the storage path control module 110 may perform the primary conversion of the file format of the stored file into a well-known, commonly used text image format, such as PDF or XPS, or may perform primary conversion between compatible file formats, such as “*.ppt” and “*.pptx”, “*.doc” and “*.docx,” or “*.xls” and “*.xlsx” that are related to the same application and are different versions of file formats, and then perform secondary conversion adapted to restore the converted format to an original file format. Through this file format conversion, various types of malicious code attached to the corresponding stored file may be separated therefrom, thereby enabling the stored file to be executed as filtered secure data.

For reference, the stored file entering through the data feed means 200 may be inspected via the storage path control module 110, and may be stored in a general storage area inside the terminal or in an isolated space from which illegitimate exit is prohibited. Additionally, although technology for inspecting and storing a stored file in real time when the corresponding stored file enters into the terminal has been disclosed in the embodiment according to the present invention, it is clearly noted that the system and method for inspecting data according to the present invention is not limited thereto but may perform inspection on a stored file already stored in the terminal.

Meanwhile, during the primary conversion of the file format of the stored file, execution information, such as a function, an equation, a macro and the like, included in the stored file may be lost, and during the secondary conversion adapted to restore the file format of the stored file to an original format, the lost execution information is not restored. Accordingly, it is preferred that the stored file is a file of a general text format.

Although the storage path control module 110 may improve the security of the stored file by performing encryption on the stored file whose file format has been converted, the encryption processing does not necessarily need to be performed on the stored file.

For reference, the isolated space 141 may be generated in the storage disk 140 inside the terminal 100, and may be newly formed in the storage disk 140 or a movable storage medium itself after the connection of the data feed means 200 has been detected. The isolated space 141 may be formed to be of a general folder type or a virtual drive type, and a detailed description thereof will be given below.

The isolated space management module 120 generates and manages the separate isolated space 141 in the storage disk 140 inside the terminal 100 or a movable storage medium so that the stored file entering from the data feed means 200 can be stored and managed in a limited range.

As described above, the isolated space 141 is a storage space adapted to prevent the stored file of the data feed means 200 from being executed or leaked by malicious code or an unauthorized application. The isolated space management module 120 may perform processing so that the isolated space 141 always resides in the storage disk 140, or may temporarily generate the isolated space 141 in the storage disk 140 or a movable storage medium after the connection of the data feed means 200 to the drive 130 has been detected.

Meanwhile, the isolated space management module 120 identifies a connection path between the data feed means 200 and the isolated space 141 and an application attempting to connect with the isolated space 141, and blocks a task when an authorized application attempts to connect with the isolated space or when an application that executes the stored file inside the isolated space 141 attempts to store the stored file in another space. As a result, the leakage of the stored file of the isolated space 141 to the outside is prevented, thereby establishing an environment with desirable security.

The isolated space 141 may be of, for example, a folder type or a virtual drive type. The isolated space 141 of a folder type has an advantage in that the transfer and processing speeds of the stored file are high because it can immediately receive and store the stored file of the data feed means 200, but has a disadvantage in that security is relatively vulnerable because a user may open a folder and illegitimately copy and leak the stored file.

The isolated space 141 of a virtual drive type has a disadvantage in that the transfer and processing speeds of the stored file of the data feed means 200 are low because the stored file is encrypted and then stored, but has an advantage in that security is desirable because it is difficult to connect with a virtual drive and execute the encrypted stored file.

Furthermore, when the isolated space management module 120 detects the data feed means 200 connecting with the drive 130 and generates the isolated space 141, an advantage arises in that security is desirable because a record of the stored file does not remain in the terminal 100, but a disadvantage arises in that an initial execution speed is low. In contrast, when the isolated space 141 resides in the storage disk 140 of the terminal 100, the inconvenience of deleting the data of the isolated space 141 at predetermined periods is caused because a record of the stored file remains in the terminal 100, but an advantage arises in that an initial execution speed is high.

However, in spite of the disadvantage based on the type of isolated space 141, the system for inspecting data according to the present invention overcomes the problem in which the stored file of the data feed means 200 is infected with malicious code, in which the terminal 100 is infected with malicious code linked to the stored file, or in which the stored file is transferred to the terminal 100 and then illegitimately leaked.

A case in which the stored file of the data feed means 200 or an e-mail server is stored and executed based on the system for inspecting data according to the present invention is described in greater detail below.

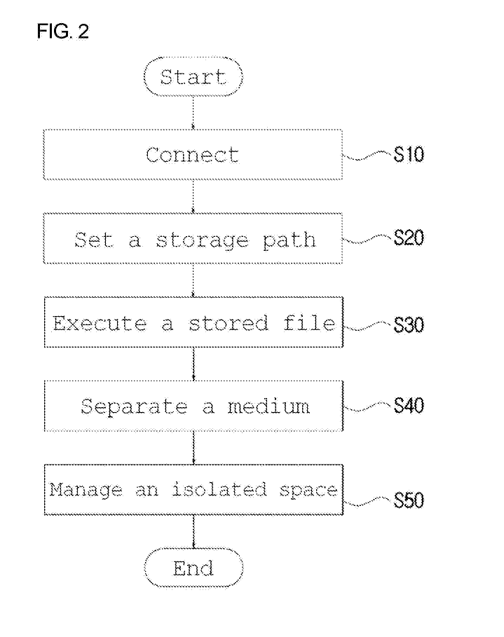

FIG. 2 is a flowchart sequentially showing a method of inspecting data according to the present invention, and the following description is given with reference to this drawing.

S10: Connection Step

The data feed means 200 is connected to the corresponding drive 130 of the terminal 100. As an example, USB memory, a smart phone, an external hard disk and the like are connected to the corresponding drive 130 via a USB cable, and a CD/DVD is connected to the drive 130 by inserting it into a dedicated reader. Furthermore, an e-mail server is accessed via a web browser, and then a connection is made to the corresponding dedicated drive 130.

Meanwhile, in the case where programming is performed such that the isolated space 141 is formed only when the isolated space 141 that resides in the storage disk 140 of the terminal 100 has not been generated or when the system for inspecting data according to the present invention connects with the data feed means 200, the isolated space management module 120 generates the isolated space 141 in the storage disk 140 or a movable storage medium. In this case, as described above, the isolated space 141 may be of a folder type or a virtual drive type.

In the present embodiment, an example in which the isolated space 141 is of a folder type is described.

For reference, the stored file entering from the data feed means 200 may be stored in the isolated space 141 through the conversion of a file format, and may be stored in the storage space of the terminal 100 without change and the separate isolated space 141. The conversion of the file format according to the present invention is intended to inspect the corresponding stored file, and the corresponding stored file does not necessarily require separate isolation after the inspection.

Only an embodiment in which an inspected stored file is stored in the isolated space 141 is described in greater detail below. However, the inspected stored file does not necessarily need to be stored in the isolated space 141.

S20: Storage Path Setting Step

When the data feed means 200 connects with the drive 130 and then communication is performed, the storage path control module 110 may control an OS so that the entry path of the stored file entering from the data feed means 200 is restricted to the isolated space 141 or a movable storage medium.

The following embodiments may be proposed as a method of restricting a storage path.

First, a user is prohibited from directly opening the drive 130 with which the data feed means 200 connects. For this purpose, the storage path control module 110 controls the OS so that the drive 130 is prohibited from being directly posted or so that the user is prohibited from executing the drive 130 through clicking even when the drive 130 is output.

This is intended to prevent the user from opening the drive 130 and then copying a stored file to another storage space.

Second, when the stored file is executed via an application, a storage location, other than the isolated space 141, is prohibited from being selected. This is intended to prevent the user from copying a stored file of the data feed means 200 to another storage space using a “Save As New Name” or “Save as Another Name” function in the application.

As a result, the user may limitedly store the stored file in the isolated space 141 in the application. Furthermore, the stored file that is stored in the data feed means 200 is executed by a dedicated application that connects with the drive 130, and changed data, such as a backup file that is data that may be generated during execution, the same file that is stored as a new name, and an auxiliary file, such as a registry or the like, that is used for the execution of the stored file, is stored in the isolated space 141.

The storage path setting step S20 may further include a “stored file inspection step” at which the storage path control module 110 performs the primary and secondary conversion of the file format of the stored file entering via the data feed means 200. More specifically, at the stored file inspection step, when the stored file transferred from the data feed means 200 is received, the storage path control module 110 primarily converts the file format of the stored file into a designated format and then performs secondary conversion adapted to restore the converted file format to an original file format. During this process, various types of malicious code attached to the stored file are eliminated, and only the original data of the stored file remains.

The stored file inspected described above may be stored in the storage disk 140 or specific isolated space 141 of the terminal 100.

Meanwhile, when the isolated space 141 is of a virtual drive type, the stored file that is copied from the movable storage medium by a user may be encrypted before being stored in the isolated space 141.

Since the virtual drive is not configured in the form of hardware but is configured in the existing storage disk 140 in the form of a type of file, separate processing is required to store a new file in the virtual drive. Accordingly, when the storage of the stored file in the isolated space 141 is attempted, the storage path control module 110 operating based on the virtual drive type of isolated space 141 may perform encryption so that the stored file can be stored in the virtual drive type of isolated space 141.

It will be apparent that when a dedicated application attempts to execute the corresponding stored file, the storage path control module 110 decrypts the stored file, thereby enabling the dedicated application to normally execute the stored file.

S30: Stored File Execution Step

The user executes the stored file stored in the movable storage medium or the isolated space 141 by executing a dedicated application, and performs a required task. The execution and the performance of the task are achieved by the dedicated application.

S40: Medium Separation Step

The user may store the stored file, executed, updated and stored in the isolated space 141 by the dedicated application, in the movable storage medium, thereby enabling the corresponding stored file stored in the movable storage medium to be updated. In this case, the drive 130 configured in the terminal 100 may include a plurality of drives, and accordingly a plurality of movable storage media may connect with the single terminal 100. Accordingly, the storage path control module 110 identifies the source of the stored file currently being executed, and transfers and stores the corresponding stored file to and in only the movable storage medium of the drive 130 identified as the source.

Thereafter, the user may separate the movable storage medium from the drive 130, thereby terminating the security execution processing of the stored file according to the present invention.

S50: Isolated Space Management Step

When the connection with the drive 130 is released via the separation of the movable storage medium or the release of the connection with the e-mail server, the isolated space management module 120 may eliminate the corresponding isolated space 141 generated in the storage disk 140 of the terminal 100, or may delete the file stored in the corresponding isolated space 141 in the case of the residing isolated space 141.

Although the above description has been given with reference to the preferred embodiments of the present invention in the above detailed description of the present invention, it will be appreciated by those skilled in the corresponding art or those having ordinary knowledge in the corresponding art that the present invention may be modified and altered in various manners without departing from the spirit and technical scope of the present invention that are set forth in the following claims.

1. A method for inspecting data through file format conversion, comprising:
a stored file inspection step of converting a file format of a stored file inside a terminal and then restoring the converted file format to an original file format.

2. The method of claim 1, further comprising, before the stored file inspection step:
a connection step of identifying, by a storage path control module, a data feed means that connects with the terminal and setting, by the data feed means, a storage path of the stored file entering from the data feed means.

3. The method of claim 2, wherein:
when the data feed means connects with the terminal, an isolated space management module generates an isolated space in a storage disk of the terminal or a movable storage medium, which is the data feed means; and
the connection step further comprises a step of setting, by the storage path control module, the storage path of the stored file as the isolated space.

4. The method of claim 3, wherein the isolated space is of a virtual drive type.

5. The method of claim 3, further comprising:
an isolated space management step of, after a connection between the data feed means and a drive has been released, deleting, by the isolated space management module, data stored in the isolated space.

6. The method of claim 5, wherein deleting the data stored in the isolated space at the isolated space management step is performed by eliminating the isolated space.

7. The method of claim 3, further comprising:
a first step of encrypting, by the storage path control module, the stored file and changed data stored in the isolated space, and a second step of decrypting the stored file and the changed data that are executed by a dedicated application.

8. The method of 4, further comprising:
a first step of encrypting, by the storage path control module, the stored file and changed data stored in the isolated space, and a second step of decrypting the stored file and the changed data that are executed by a dedicated application.

9. The method of 5, further comprising:
a first step of encrypting, by the storage path control module, the stored file and changed data stored in the isolated space, and a second step of decrypting the stored file and the changed data that are executed by a dedicated application.

10. The method of 6, further comprising:
a first step of encrypting, by the storage path control module, the stored file and changed data stored in the isolated space, and a second step of decrypting the stored file and the changed data that are executed by a dedicated application.
